(19) United States
(12) Patent Application Publication
(10) Pub. No.: US 2010/0055471 A1
(43) Pub. Date: Mar. 4, 2010

(54) WATERBORNE POLYURETHANE DISPERSION COMPRISING BIOMASS DERIVED POLYOL AND COATINGS COMPRISING SAME

(75) Inventor: Mary Ann Fuhry, Butler, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/202,859

(22) Filed: Sep. 2, 2008

(51) Int. Cl. B32B 27/08; C08G 18/72; C08F 283/00; B32B 27/40

(52) U.S. Cl. 428/419; 528/59; 525/453; 428/423.1

(57) ABSTRACT

A water-based polyurethane dispersion comprising the reaction product of a polyol component and a polyisocyanate component, wherein the polyol component comprises at least some biomass derived polyol is disclosed. A coating comprising this dispersion is also disclosed, as are substrates coated with the coating.

### FIELD OF THE INVENTION

The present invention relates generally to water-based polyurea dispersions comprising a biomass derived polyol and a polyisocyanate. The present invention is further directed to coatings comprising such a water-based polyurethane dispersion and a crosslinker.

### BACKGROUND OF THE INVENTION

An increase in demand for environmentally friendly products has made “green” coating compositions, particularly biodegradable coatings, of interest in numerous industries. This is particularly relevant in the consumer electronics industry, where an increasing number of cellular telephones, PDAs, MP3s, and the like are finding their way to landfills. Biodegradable coatings, particularly with biodegradable plastics used in the housings of those devices, are desirable.

### SUMMARY OF THE INVENTION

The present invention includes a water-based polyurethane dispersion comprising the reaction product of:
a polyol component; and
a polyisocyanate component; wherein the polyol component comprises at least some biomass derived polyol; wherein the polyol component does not comprise epoxy or alkyd; and wherein the reaction product itself does not contain sufficient functionality to undergo oxidative cure.

The present invention also includes a coating composition comprising:
a) a water-based polyurethane dispersion comprising the reaction product of:
   i) a polyol component comprising at least some biomass derived polyol; and
   ii) a polyisocyanate component; and
b) a polycarbodiimide.

### DETAILED DESCRIPTION OF THE INVENTION

The present invention is directed to a water-based polyurethane dispersion comprising the reaction product of a polyol component and an isocyanate component. The polyol component comprises at least some biomass derived polyol, and the polyol component does not comprise epoxy or alkyd. The reaction product itself does not contain sufficient functionality to undergo oxidative cure.

Any polyol can be used according to the present invention. Suitable polyols can include, but are not limited to, small molecules containing more than one hydroxyl group, for example neopentyl glycol, glycerol, isosorbide, pentraerythritol and/or propanediol, or polymeric polyols such as a polyester polyols or an acrylic polyols. Suitable polyols are widely commercially available. Particularly suitable polyols have a number average molecular weight as determined by GPC (“Mn”) of 500 to 100,000, such as 500 to 10,000. In certain embodiments, the polyols can have hydroxyl values of 20 to 400, such as 40 to 300; in other embodiments, the hydroxyl value can range from 1200 to 2100, such as 1400 to 1900.

As noted above, at least some of the polyol is biomass derived. A biomass derived compound will be understood to be a compound derived from a living or recently living organism, for example, plants (including trees) or animals and not from a petroleum based source. In certain embodiments, 10 to 100, such as 15 to 75 or 20 to 50 weight %, with weight % based on total solids weight of the polyol component, comprise a biomass derived polyol. As used herein, reference to “at least some” polyol being biomass derived means that the biomass derived polyol is not merely present as an impurity. For example, the polyol can comprise at least 5 weight %, such as at least 10 weight %, biomass derived polyol, with weight % based on total weight of the polyol.

Biomass derived polyols can be derived from natural oils such as castor oil, peanut oil, soy bean oil or canola oil. The hydroxyl groups present in the biomass derived polyol can be naturally occurring or they can be introduced, for example by modification of carbon-carbon double bonds present in the oils. Natural oil derived polyols are described in United States Patent Publication Number 2006/0041156 A1, U.S. Pat. No. 7,084,230, WO 2004/096882 A1, U.S. Pat. No. 6,686,435, U.S. Pat. No. 6,107,433, U.S. Pat. No. 6,573,354 and U.S. Pat. No. 6,433,121, all of which are incorporated in their entirety herein. Methods of modifying carbon-carbon double bonds to introduce hydroxyl groups include treatment with ozone, air oxidation, reaction with peroxides or hydroformylation (as described in “Polyols and Polyurethanes from Hydroformylation of Soybean Oil”, Journal of Polymers and the Environment, Volume 10, Numbers 1-2, pages 49-52, April, 2002, incorporated herein in its entirety). A particularly suitable biomass derived polyol is a soy polyol. Soy polyols are commercially available from Cargill Inc., Urethane Soy Systems Co. and BioBased Technologies. In certain other embodiments, the polyol is derived from a recycled polymer, such as a polyester.

In certain embodiments, the polyol component does not comprise an epoxy moiety or an alkyd moiety. As used herein, when it is said that the polyol component does not comprise an epoxy moiety, or like terms, this means that the polyol component does not have an epoxy group, an oxirane ring, or any residues thereof; that is, the polyol component is not epoxy functional, nor is it the reaction product of an epoxy functional compound and one or more other compounds.

“Alkyd moiety” and like terms will be understood as referring to the reaction product of a polybasic acid and a polyhydric alcohol in the presence of an oil or fatty acid, or a residue thereof. As used herein, when it is said that the polyol component does not comprise an alkyd moiety, or like terms, this means that there is no alkyd moiety in the polyol component and that an alky was not used in forming the polyol component.

The polyisocyanate component can comprise any suitable isocyanate. Suitable polyisocyanates include, for example, multifunctional isocyanates. Examples of multifunctional isocyanates include aliphatic diisocyanates like hexamethylene diisocyanate and isophorone diisocyanate, and aromatic diisocyanates like toluene diisocyanate and 4,4′-diphenylmethane diisocyanate. The polyisocyanates can be blocked or unblocked. Examples of other suitable polyisocyanates include isocyanurate trimers, allophanates, and uretdiones of diisocyanates. Suitable polyisocyanates are well known in the art and widely available commercially. For example, suitable polyisocyanates are disclosed in U.S. Pat. No. 6,316,119 at columns 6, lines 19-36, incorporated by reference herein. Examples of commercially available polyisocyanates include DESMODUR N3390, which is sold by Bayer Corporation, and TOLONATE HDT90, which is sold by Rhodia Inc.

The reaction product itself in the water-based polyurethane dispersions of certain embodiments of the present invention does not contain sufficient functionality to undergo oxidative cure. “Oxidative cure” means cure at ambient temperature upon exposure to air. Thus, the water-based polyurethane dispersion according to certain embodiments of the present invention is distinct, for example, from compounds comprising alkyds, oils, and the like that have sufficient double bonds to oxidatively cure, sometimes referred to in the art as “air drying” and the like. As noted above, the reaction product “itself” does not contain sufficient functionality to undergo oxidative cure; that is, the reaction product will not oxidatively cure with itself.

The polyol component used in forming the water-based polyurethane dispersion of the present invention comprises at least some biomass derived polyol, and may also comprise one or more additional polyols. In certain embodiments, these polyols may include an acid functional polyol, such as dimethylolpropanoic acid (DMPA).

Upon reaction of a polyol component comprising acid functionality with the polyisocyanate component, the reaction product may further be extended with any suitable chain extender such as a polyamine and/or a (poly)hydrazide. Suitable chain extenders include, for example, adipic dihydrazide, ethylene diamine, 1,6-hexanediamine, sebacic dihydrazide, succinic acid dihydrazide, citric acid trihydrazide. The polymer can then be dispersed in water in the presence of a neutralizing amine, such as dimethylethanolamine.

In certain embodiments, the ratio of hydroxy groups to isocyanate groups, that is, OII:NCO, is 0.6-0.8:1.0, 0.5-0.9:1.0 or 0.4-1.0:1.0.

The present invention is further directed to a coating comprising any of the water-based polyurethane dispersions described herein and a crosslinker. Any suitable crosslinker can be used, including any of the polyisocyanates listed above, aminoplasts, polyepoxides, beta hydroxyalkylamides, polyacids, and hydrides, organometallic acid-functional materials, polyamines, polyamides, and mixtures of any of the foregoing. Suitable aminoplasts include condensates of amines and or amides with aldehyde. For example, the condensate of melamine with formaldehyde is a suitable aminoplast. Suitable aminoplasts are well known in the art. A suitable aminoplast is disclosed, for example, in U.S. Pat. No. 6,316,119 at column 5, lines 45-55, incorporated by reference herein.

In certain embodiments, the crosslinker comprises a carbodiimide. A “carbodiimide” will be understood as a compound comprising the functional group —N═C═N—. Suitable carbodiimides and methods for making the same are described in U.S. patent application Ser. No. 12/056,306, which is incorporated herein in its entirety, and are also commercially available, such as CARBODILITE V-02-L2, from Nisshinbo.

Certain embodiments of the present invention are directed to coating compositions comprising a water-based polyurethane dispersion and a polycarbodiimide. The dispersion comprises the reaction product of a polyol component and a polyisocyanate component; the polyol component comprises at least some biomass derived polyol. Any polyol and isocyanate described above, in any weight % or ratio described above, can be used in this embodiment, as can any polycarbodiimide. In addition, the polyol component in these embodiments may comprise epoxy and/or alkyd and/or a moiety of either or both.

The coatings of the present invention can comprise 70 to 99 weight %, such as 85 to 95 or 90 to 93 weight % of any of the water-based polyurethane dispersions described above with weight % based on total solid weight of the coating. The coatings can comprise 1 to 30, such as 5 to 15 or 7 to 10 weight % of crosslinker, with weight % based on total solid weight.

It has been surprisingly discovered that certain embodiments of the present coatings are biodegradable. A biodegradable composition will be understood as one in which the organic substances that comprise the composition are broken down by living organisms, such as in the presence of oxygen (aerobically) or without oxygen (anaerobically). Certain compositions of the current invention can be biodegradable under aerobic conditions, such as industrial or domestic composting.

It will be appreciated that the polyurethane dispersion of the present invention, when used in any of the coatings according to the present invention, can form all or part of the film-forming resin of the coating. In certain embodiments, one or more additional film-forming resins are also used in the coating. For example, the coating compositions can comprise any of a variety of thermoplastic and/or thermosetting compositions known in the art.

Thermosetting or curable coating compositions typically comprise film-forming polymers or resins having functional groups that are reactive with either themselves or a crosslinking agent. The additional film-forming resin can be selected from, for example, acrylic polymers, polyester polymers, polyurethane polymers, polyamide polymers, polyether polymers, polysiloxane polymers, copolymers thereof, and mixtures thereof. Generally these polymers can be any polymers of these types made by any method known to those skilled in the art. Such polymers may be solvent borne or water dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof.

Appropriate mixtures of film-forming resins may also be used in the preparation of the present coating compositions.

Thermosetting coating compositions typically comprise a cross linking agent that may be selected from, for example, any of the crosslinkers described above. In certain embodiments, the present coatings comprise a thermosetting film-forming polymer or resin and a cross linking agent therefor. This thermosetting composition can be selected such that the crosslinker is the same or different than the crosslinker used to crosslink the polyurethane in the dispersion. In certain other embodiments, a thermosetting film-forming polymer or resin having functional groups that are reactive with themselves are used; in this manner, such thermosetting coatings are self-crosslinking.

As noted above, the polyurethane dispersions are water-based or aqueous, and therefore predominantly contain water as the solvent, or as the continuous phase of a dispersion in which organic solvents are present in only minimal quantities, if at all, such as less then 20 weight %, less than 10 weight %, less then 5 weight %, or less than 2 weight %, with weight % based on total weight of the coating. If solvent is used in minimal quantities, it can be any suitable organic solvent such as glycols, glycol ether alcohols, alcohols, ketones, and aromatics such as xylene and toluene, acetates, mineral spirits, naphthas and/or mixtures thereof. “Acetates” include the glycol ether acetates. The solvents can be biomass derived. Examples of biomass derived solvents include esters of lactic acid and esters of soy bean oil fatty acid.

If desired, the coating compositions can comprise other optional materials well known in the art of formulating coatings in any of the components, such as colorants, abrasion resistant particles, plasticizers, anti-oxidants, hindered amine light stabilizers, UV light absorbers and stabilizers, surfactants, flow control agents, thixotropic agents, fillers, organic cosolvents, reactive diluents, catalysts, grind vehicles, and other customary auxiliaries.

An “abrasion resistant particle” is one that, when used in a coating, will impart some level of abrasion resistance to the coating as compared with the same coating lacking the particles. Suitable abrasion resistant particles include organic and/or inorganic particles. Examples of suitable organic particles include but are not limited to diamond particles, such as diamond dust particles, and particles formed from carbide materials; examples of carbide particles include but are not limited to titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles. For example, the particles can be microparticles, having an average particle size of 0.1 to 50, 0.1 to 20, 1 to 12, 1 to 10, or 3 to 6 microns, or any combination within any of these ranges. The particles can be nanoparticles, having an average particle size of less than 0.1 micron, such as 0.8 to 500, 10 to 100, or 100 to 500 nanometers, or any combination within these ranges.

As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference in its entirety. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Serial Number 2005-0287348 A1, filed Jun. 24, 2004, which is incorporated herein by reference it its entirety, United States Patent Application Publication Number 2005-0287348 A1, filed Jun. 24, 2004, and United States Patent Application Publication Number 2006-0251897, filed Jan. 20, 2006, which are also incorporated herein by reference in their entirety.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference in its entirety. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference in its entirety.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The present coatings can be applied to any substrates known in the art, for example automotive substrates, industrial substrates and consumer substrates. These substrates can be, for example, metallic or non-metallic, including polymeric, plastic, polycarbonate, polycarbonate/acrylobutadiene styrene (“PC/ABS”), polyamide, wood, veneer, wood composite, particle board, medium density fiberboard, cement, stone, and the like. In a particularly suitable embodiment of the present invention, the substrate itself is biodegradable. Biodegradable substrates include, for example paper, wood and biodegradable plastics such as cellulose, poly(lactic acid), poly(3-hydroxybutyrate) and starch based plastics. In addition, the substrate can be one that has been recycled. The substrate can also be one that has already been treated in some manner to impart color or other visual effect. For example, a wood substrate that has been stained may then be coated according to the present invention, as can a substrate that has already had one or more other coating layers applied to it.

As used herein, the term “polyamide” in reference to a substrate means a substrate constructed from a polymer that includes repeating units of the formula:

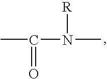

wherein R is hydrogen or an alkyl group. The polyamide may be any of a large class of polyamides based on aliphatic, cycloaliphatic, or aromatic groups in the chain. They may be formally represented by the products of condensation of a dibasic amine with a diacid and/or diacid chloride, by the product of self-condensation of an amino acid, such as omega-aminoundecanoic acid, or by the product of a ring-opening reaction of a cyclic lactam, such as caprolactam, lauryllactam, or pyrrolidone. They may contain one or more alkylene, arylene, or aralkylene repeating units. The polyamide may be crystalline or amorphous. In certain embodiments, the polyamide substrate comprises a crystalline polyamide of alkylene repeating units having from 4 to 12 carbon atoms, such as poly(caprolactam) (nylon 6), poly(lauryllactam) (nylon 12), poly(omega-aminoundecanoic acid) (nylon 11), poly(hexamethylene adipamide) (nylon 6.6), poly(hexamethylene sebacamide) (nylon 6.10), and/or an alkylene/arylene copolyamide, such as that made from meta-xylylene diamine and adipic acid (nylon MXD6). The term “nylon” includes all of these products as well as any other compound referred to in the art as nylon. Amorphous polyamides, such as those derived from isophoronediamine or trimethylcyclohexanediamine, may also be utilized. Blends of polyamides may also be utilized.

As used herein, the term “polyamide”, when used in reference to a substrate, includes a reinforced polyamide substrate; a reinforced polyamide substrate is a polyamide substrate constructed from a polyamide that has been reinforced through the inclusion of, for example, fibrous materials, such as glass fiber or carbon fiber, or inorganic fillers, such as calcium carbonate, to produce a polyamide having increased rigidity, strength, and/or heat resistance relative to a similar polyamide that does not include such reinforcing materials. Reinforced polyamides, which are suitable for use as a substrate material in accordance with certain embodiments of the present invention, are commercially available and include, for example, those materials commercially available from Solvay Advanced Polymers under the IXEF name and, include, for example, the IXEF 1000, 1500, 1600, 2000, 2500, 3000 and 5000 series products; from EMS-Chemie Inc., Sumter, S.C., under the GRILAMID, GRIVORY, GRILON and GRILFLEX tradenames; and DuPont Engineered Polymers, such as those sold under the THERMX and MINLON tradenames.

In certain embodiments, the substrates coated according to the present invention are flexible substrates. “Flexible substrate” and like terms refer to substrates that can undergo mechanical stresses, such as bending, stretching and the like without significant irreversible change. Flexible substrates include non-rigid substrates, such as woven and nonwoven fiberglass, woven and nonwoven glass, woven and nonwoven polyester, thermoplastic urethane (TPU), synthetic leather, natural leather, finished natural leather, finished synthetic leather, rubber, urethane elastomers, synthetic textiles and natural textiles. “Textiles” can include natural and/or synthetic textiles such as fabric, vinyl and urethane coated fabrics, mesh, netting, cord, yarn and the like, and can be comprised, for example, of canvas, cotton, polyester, KEVLAR, polymer fibers, polyamides such as nylons and the like, polyesters such as polyethylene terephthalate and polybutylene terephthalate and the like, polyolefins such as polyethylene and polypropylene and the like, rayon, polyvinyl polymers such as polyacrylonitrile and the like, other fiber materials, cellulosics materials and the like.

In certain embodiments, the flexible substrate is a compressible substrate. “Compressible substrate” and like terms refer to a substrate capable of undergoing a compressive deformation and returning to substantially the same shape once the compressive deformation has ceased. The term “compressive deformation” and like terms mean a mechanical stress that reduces the volume at least temporarily of a substrate in at least one direction. A compressible substrate is one, for example, that has a compressive strain of 50% or greater, such as 70%, 75% or 80% or greater. Particular examples of compressible substrates include those comprising foam, and polymeric bladders filled with plasma, liquid or other fluid, such as nitrogen and/or air. “Foam” can be a polymeric or natural material comprising open cell foam and/or closed cell foam. “Open cell foam” means that the foam comprises a plurality of interconnected air chambers; “closed cell foam” means that the foam comprises discrete closed pores. Example foams include but are not limited to polystyrene foams, polyvinyl acetate and/or copolymers, polyvinyl chloride and/or copolymers, poly(meth)acrylimide foams, polyvinylchloride foams, polyurethane foams, thermoplastic urethane foams, and polyolefinic foams and polyolefin blends. Polyolefinic foams include but are not limited to polypropylene foams, polyethylene foams and ethylene vinyl acetate (“EVA”) foams. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface.

The coatings of the present invention can be applied by any means standard in the art, such as electrocoating, spraying, electrostatic spraying, dipping, rolling, brushing, and the like.

The coatings can be applied to any dry film thickness, such as 0.1 to 4 mils, 0.3 to 2 mils or 0.7 to 1.3 mils. The coatings of the present invention can be used alone, or in combination with one or more other coatings. For example, the coatings of the present invention can comprise a colorant or not and can be used as a primer, ecoat, basecoat, top coat, automotive repair coat and the like. For substrates coated with multiple coatings, one or more of those coatings can be coatings as described herein.

As used herein, unless otherwise expressly specified, all numbers such as those expressing values, ranges, amounts or percentages may be read as if prefaced by the word “about”, even if the term does not expressly appear. Also, any numerical range recited herein is intended to include all subranges subsumed therein. Singular encompasses plural and vice versa. For example, although reference is made herein, including the claims, to “a” polyol, “a” polyisocyanate, “a” reaction product, “an” acid functional polyol, “a” chain extender, “a” polycarbodiimide, “a” crosslinker and the like, one or more of each of these and any other component can be used. “Including” means “including, but not limited to”. As used herein, the term “polymer” refers to oligomers and both homopolymers and copolymers, and the prefix “poly” refers to two or more.

### EXAMPLES

The following examples are intended to illustrate the invention and should not be construed as limiting the invention in any way.

### Example 1

EXAMPLE 1: Waterbased polyurethane dispersion “A” was made as follows:

TABLE 1

| Ingredients | | Parts by Weight |
|---|---|---|
| TERATHANE 2000¹ | Charge #1 | 12.18 |
| 1XS 1400 AO3 Soy Polyol² | | 9.59 |
| Dimethylol Propionic Acid | | 1.95 |
| Isophorone Diisocyanate | Charge #2 | 7.26 |
| Methyl Ethyl Ketone | Charge #3 | 7.64 |
| Dibutyltin Dilaurate | Charge #4 | 0.03 |
| Deionized Water | Charge #5 | 53.17 |
| Adipic Dihydrazide | | 1.02 |
| Dimethylethanolamine | | 1.27 |
| Deionized Water | Charge #6 | 5.88 |

¹Terathane 2000 is poly(tetrahydrofuran) from BASF Corp.
²1XS 1400 AO3 is a soy polyol from Cargill.

Charge #1 was added to a 5-liter, 4-necked flask equipped with a motor driven stainless steel stir blade, a water-cooled condenser, a nitrogen inlet, and a heating mantle with a thermometer connected through a temperature feedback control device. The contents of the flask were heated to 60° C. and then Charge #2 was added, followed by Charge #3. Charge #4 was added and the reaction mixture was allowed to exotherm to about 79° C. After the exotherm, the reaction temperature was increased to 80° C. and the mixture was held at this temperature for about 3 h, during which time the NCO eq wt reached about 2000. The batch temperature was decreased to 50° C. and then Charge #5, after being preheated to 45° C., was added over 20 minutes to the batch. The reaction mixture was then thinned with Charge #6 to provide a stable polyurethane dispersion.

### Example 2

A comparative waterbased polyurethane dispersion “B” was made using a process similar to that used for polyurethane “A” with the composition shown in Table 2. In this case, the methyl ethyl ketone was stripped from the dispersion as follows: A small amount (1-2 drops) of defoamer, BYK-011 from Byk Chemie, was added to the batch. The reaction flask was attached to a vacuum pump, and the methyl ethyl ketone (along with some of the water) was distilled off at 60° C. and 440-310 mmHg. The batch was then thinned further with 500 g deionized water to provide a stable polyurethane dispersion.

TABLE 2

| Ingredients | | Parts by Weight |
|---|---|---|
| TERATHANE 2000 | Charge #1 | 21.85 |
| Dimethylol Propionic Acid | | 1.96 |
| Isophorone Diisocyanate | Charge #2 | 7.29 |
| Methyl Ethyl Ketone | Charge #3 | 7.67 |
| Dibutyltin Dilaurate | Charge #4 | 0.03 |
| Deionized Water | Charge #5 | 58.90 |
| Adipic Dihydrazide | | 0.90 |
| Dimethylethanolamine | | 1.37 |

### Examples 3 and 4

A thermosetting water-based composition comprising either the carboxylic acid group containing polyurethane of Example 1, or the comparative polyurethane of Example 2, and a polycarbodiimide crosslinker was prepared. The compositions were prepared from the ingredients shown in Table 3.

TABLE 3

Amount in Grams

| | | Comparative |
|---|---|---|
| Ingredient | Ex. 3 | Ex. 4 |
| Polyurethane Dispersion “A” | 197 | — |
| Polyurethane Dispersion “B” | — | 166 |
| TEGO WET 280¹ | 3.0 | 3.0 |
| BYK 425² | 0.3 | 0.3 |
| BYK 011³ | 1.4 | 1.4 |
| 2-Ethyl Hexanol | 2.8 | 2.8 |
| Zonyl FSH⁴ | 1.7 | 1.7 |
| Monarch Black⁵ | 22.5 | 22.5 |
| Blue Pigment⁶ | 1.7 | 1.7 |
| White Pigment⁷ | 4.8 | 4.8 |
| CARBODILITE V-02-L2⁸ | 25.9 | 25.9 |
| Water | 0 | 15 |

¹Silicon flow additive from Goldschmidt Chemical.
²Rhelogy agent from BYK Chemie.
³Degassing agent from BYK Chemie.
⁴Fluorosurfactant from DuPont.
⁵Waterborne tint paste in black, prepared as follows: The pigment was dispersed in a premix of: acrylic resin grind vehicle, amine and polar solvents (including deionized water) under cowles agitation. The initial pH was recorded. Once a uniform dispersion of the tint intermediate was achieved, the cowles equipment was substituted for a sandmill (blade without teeth) and beaded media to finely disperse the pigment to a grind that measured 7 on a Hegman scale. Once a 7+ grind was achieved, the intermediate tint paste was sifted through a strainer to retrieve the beaded media from the tint. A final pH of the finished tint was taken and, if necessary, was adjusted with amine to the initial pH measurement.
⁶Waterborne tint paste in blue, prepared as described above.
⁷Waterborne tint paste in white, prepared as described above.
⁸Polycarbodiimide crosslinker from Nisshinbo Ind.

The thermosetting compositions were spray applied to substrates as mentioned below, cured at 170° C. for 20 minutes to give cured coatings having a film build of about 1 mil. The coated substrates were tested for flexibility and compression resistance. The results of the testing are reported below:

TABLE 4

| Example | MEK¹ | Compression² | Flexibility³ |
|---|---|---|---|
| 3 | 50 | Pass | 20,000 |
| 4 | 50 | Pass | 80,000 |

¹To perform the methyl ethyl ketone (MEK) test, a cotton swab was dipped in MEK and then rubbed across an area of the cured film. The test was considered a pass, if, after 50 double (back and forth) rubs, there was no solid on the cotton.
²The compression test measures the repeated compression of a flexible polyurethane substrate such as that used for athletic shoe midsoles by simulating the up and down running motion of the shoe. A sample of the substrate, approximately 2.5 square centimeters and 2.5 centimeters in thickness, was coated as described above and was placed in a holder. A plate directly above the holder impacted the sample to the extent that the material was compressed to 50% of its original height. The compressed dimensions are therefore approximately 2.5 × 2.5 × 1.75 centimeters. The impacting/compressing repeated itself 5-10 times per second and continues until either the coating fails or the counter reached 100,000 cycles. One cycle was one compression/one relaxation, two cycles was two compressions/two relaxations.
³The flexibility test used a Bally Flexometer. In the test, a flexible polyurethane substrate such as that used for athletic shoe uppers, of approximately 2.5 square centimeters and about 3 millimeters in thickness, was coated as described above. The sample was placed in a jig and folded 90 degrees (coating side out) to simulate the bending experienced by the front of an athletic shoe when used for running. The sample was given 20,000 folds and inspected for cracks in the coating If no cracks were evidenced the sample was given another 20,000 folds and examined again for cracks in the coating. The testing was continued until the coating cracked.

As demonstrated in Table 4, the coating made according to the present invention having the biomass derived polyol had solvent resistance and compression comparable to a coating without the biomass derived polyol, although the flexibility was not as high. This may be due to a higher level of branching in the biomass derived polyol version, although the inventors do not wish to be bound by this. Whether the MEK was stripped from the dispersion or not was determined not to affect the properties of the coating.

Whereas particular embodiments of this invention have been described above for purposes of illustration, it will be evident to those skilled in the art that numerous variations of the details of the present invention may be made without departing from the invention as defined in the appended claims.

1. A water-based polyurethane dispersion comprising the reaction product of:
a polyol component; and
a polyisocyanate component; wherein the polyol component comprises at least some biomass derived polyol; wherein the polyol component does not comprise epoxy or alkyd; and wherein the reaction product itself does not contain sufficient functionality to undergo oxidative cure.

2. The dispersion of claim 1, wherein the biomass derived polyol comprises soy polyol.

3. The dispersion of claim 2, wherein the soy polyol has an average functionality of 2 to

4. The dispersion of claim 1, wherein the polyol component further comprises an acid functional polyol.

5. The dispersion of claim 4, wherein the acid functional polyol comprises DMPA.

6. The dispersion of claim 5, wherein the reaction product is further reacted with a chain extender.

7. The dispersion of claim 6, wherein the chain extender comprises polyamine and/or polyhydrazide.

8. The dispersion of claim 7, wherein the polyhydrazide comprises adipic dihydrazide.

9. A coating composition comprising:
a) the water-based polyurethane dispersion of claim 1; and
b) a crosslinker.

10. The coating composition of claim 9, wherein the crosslinker comprises polycarbodiimide.

11. The coating composition of claim 10, wherein the biomass derived polyol is soy polyol.

12. The coating of claim 10, wherein the polyol component further comprises an acid functional polyol.

13. The coating of claim 12, wherein the acid functional polyol comprises DMPA.

14. A substrate coated with the coating of claim 9.

15. The substrate of claim 14, wherein the substrate is polymeric.

16. The substrate of claim 15, wherein the substrate is PC/ABS.

17. The substrate of claim 14, wherein the substrate is biodegradable.

18. The substrate of claim 14, wherein the substrate is flexible.

19. The substrate of claim 18, wherein the substrate is compressible.

20. The substrate of claim 18, wherein the substrate comprises polyurethane foam.

21. The substrate of claim 18, wherein the substrate comprises EVA foam.

22. A coating composition comprising:
a) a water-based polyurethane dispersion comprising the reaction product of:
i) a polyol component; and
ii) a polyisocyanate component, wherein the polyol component comprises at least some biomass derived polyol; and
b) a polycarbodiimide.

23. The coating of claim 22, wherein the biomass derived polyol comprises soy polyol.

24. A substrate coated with the coating of claim 22.

25. The water-based polyurethane dispersion of claim 1, wherein the polyol component comprises 5 to 75 weight %, based on total solid weight of the polyol component, of biomass derived polyol.

26. The coating of claim 9, wherein the polyol component comprises 5 to 75 weight %, based on total solid weight of the polyol component, of biomass derived polyol.

27. The coating of claim 22, wherein the polyol component comprises 5 to 75 weight %, based on total solid weight of the polyol component, of biomass derived polyol.
